(19) United States
(12) Patent Application Publication
(10) Pub. No.: US 2025/0042157 A1
(43) Pub. Date: Feb. 6, 2025

(54) PRINTING APPARATUS, PRINTING SYSTEM, AND DATABASE

(71) Applicant: SEIKO EPSON CORPORATION, Tokyo (JP)

(72) Inventor: Takashi AKASE, Azumino-Shi (JP)

(21) Appl. No.: 18/793,120

(22) Filed: Aug. 2, 2024

(30) Foreign Application Priority Data
Aug. 4, 2023 (JP) 2023-127794
Aug. 4, 2023 (JP) 2023-127795

(51) Int. Cl. B41J 2/165; G06K 15/00; G06K 15/10

(52) U.S. Cl. CPC B41J 2/16579; B41J 2/16505; G06K 15/102; G06K 15/408

(57) ABSTRACT

Included are: a printing head including a plurality of nozzles configured to discharge a liquid; a cleaning unit configured to perform cleaning of the printing head; a detector configured to perform a faulty-nozzle detecting process to each of the plurality of nozzles, the faulty-nozzle detecting process being a process of detecting a faulty nozzle that does not perform discharging properly; a database configured to store cause data used to determine a cause of a discharging fault of the nozzle; and a control unit, in which the control unit checks faulty nozzle information against the cause data to select cleaning to be performed by the cleaning unit, the faulty nozzle information including a position, in the printing head, of the faulty nozzle detected by the detector.

The present application is based on, and claims priority from JP Application Serial Number 2023-127794, filed on Aug. 4, 2023, and 2023-127795 filed on Aug. 4, 2023, the disclosures of which are hereby incorporated by reference herein in its entirety.

### BACKGROUND

### 1. Technical Field

The present disclosure relates to a printing apparatus, a printing system, and a database.

### 2. Related Art

As in, for example, JP-A-2005-212433, there is a printing apparatus configured to discharge ink serving as one example of a liquid from a nozzle to perform printing. The printing apparatus performs a cleaning process in which ink is forcibly sucked and ejected from the nozzle, thereby removing clogging of the nozzle. Clogging of a nozzle occurs due to ink drying within a nozzle at the time of printing. Thus, the printing apparatus selects a type of cleaning depending on the number of printing passes.

Clogging of a nozzle also occurs, for example, due to a foreign material attached on the nozzle, or air bubbles coming into a nozzle. Thus, there is a possibility of consuming a liquid more than necessary if the type of cleaning is selected only depending on the number of printing passes.

### SUMMARY

A printing apparatus that solves the problem described above include a printing head including a plurality of nozzles configured to discharge a liquid, a cleaning unit configured to perform cleaning of the printing head, a detector configured to perform a faulty-nozzle detecting process to each of the plurality of nozzles, the faulty-nozzle detecting process being a process of detecting a faulty nozzle that does not perform discharging properly, a database configured to store cause data used to determine a cause of a discharging fault of the nozzle, and a control unit, in which the control unit checks faulty nozzle information against the cause data to select cleaning to be performed by the cleaning unit, the faulty nozzle information including a position, in the printing head, of the faulty nozzle detected by the detector.

A printing system that solves the problem described above includes a printing head including a plurality of nozzles configured to discharge a liquid, a cleaning unit configured to perform cleaning of the printing head, a detector configured to perform a faulty-nozzle detecting process to each of the plurality of nozzles, the faulty-nozzle detecting process being a process of detecting a faulty nozzle that does not perform discharging properly, a database configured to store cause data used to determine a cause of a discharging fault of the nozzle, and a control unit, in which the control unit checks faulty nozzle information against the cause data to select cleaning to be performed by the cleaning unit, the faulty nozzle information including a position, in the printing head, of the faulty nozzle detected by the detector.

A database that solves the problem described above is used by a printing apparatus, the printing apparatus including a printing head including a plurality of nozzles configured to discharge a liquid, a cleaning unit configured to perform cleaning of the printing head, a detector configured to perform a faulty-nozzle detecting process to each of the plurality of nozzles, the faulty-nozzle detecting process being a process of detecting a faulty nozzle that does not perform discharging properly, and a control unit, in which the printing apparatus checks faulty nozzle information against the database to select cleaning to be performed by the cleaning unit, the faulty nozzle information including a position, in the printing head, of the faulty nozzle detected by the detector, and the database is configured to store cause data used to determine a cause of a discharging fault of the nozzle.

### BRIEF DESCRIPTION OF THE DRAWINGS

FIG. 1 is a schematic view of an embodiment of a printing system.

FIG. 2 is a schematic view of the internal configuration of a printing apparatus.

FIG. 3 is a schematic view of a nozzle surface having a discharging fault having a first pattern.

FIG. 4 is a schematic view of a nozzle surface having a discharging fault having a second pattern.

FIG. 5 is a schematic view of a nozzle surface having a discharging fault having a third pattern.

FIG. 6 is a schematic view of a nozzle surface having a discharging fault having a fourth pattern.

FIG. 7 is a schematic view of a nozzle surface having a discharging fault having a fifth pattern.

FIG. 8 is a flowchart showing a display routine.

### DESCRIPTION OF EMBODIMENTS

### Embodiment

Below, an embodiment of a printing system, a printing apparatus, a database, a display method, a display device, and an information processing method will be described with reference to the drawings. The printing apparatus is an ink jet-type printer that discharges ink serving as an example of a liquid onto a medium such as a sheet, fabric, vinyl, a plastic component, or a metal component, and performs printing.

### Printing System

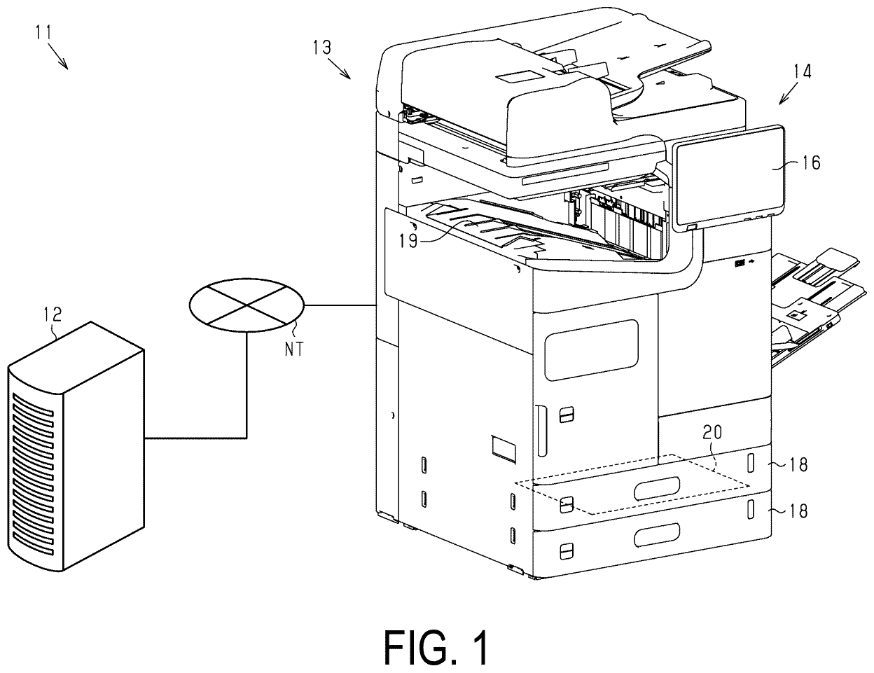

As illustrated in FIG. 1, a printing system 11 includes a server device 12, one or more printing apparatuses 13, and one or more display devices 14. The server device 12 may be coupled to each of the plurality of printing apparatuses 13 and the plurality of display devices 14 directly or through a network NT. The term “couple” means electrical coupling, is not limited to wired coupling, and also includes wireless coupling. The server device 12 may be able to communicate with each of the plurality of printing apparatuses 13. The plurality of printing apparatuses 13 may be able to communicate with each other.

### Display Device

The display device 14 includes a display unit 16 that is able to display information using an image or characters. The display device 14 may be a display or may be a touch panel. The display device 14 may be provided in the printing apparatus 13, or may be provided separately from the printing apparatus 13. That is, the printing apparatus 13 may include the display unit 16 that is able to display information. The display device 14 may be provided so as to be attached to or detached from the printing apparatus 13. The display device 14 displays information outputted by the printing apparatus 13. The display device 14 may be coupled directly or through the network NT to the printing apparatus 13.

### Printing Apparatus

As illustrated in FIG. 1, the printing apparatus 13 may include one or more medium accommodation units 18 and a stacker 19. The medium accommodation unit 18 is, for example, a cassette. The medium accommodation unit 18 may accommodate a bunch of media 20 before printing. The stacker 19 accommodates media 20 on which printing has been performed.

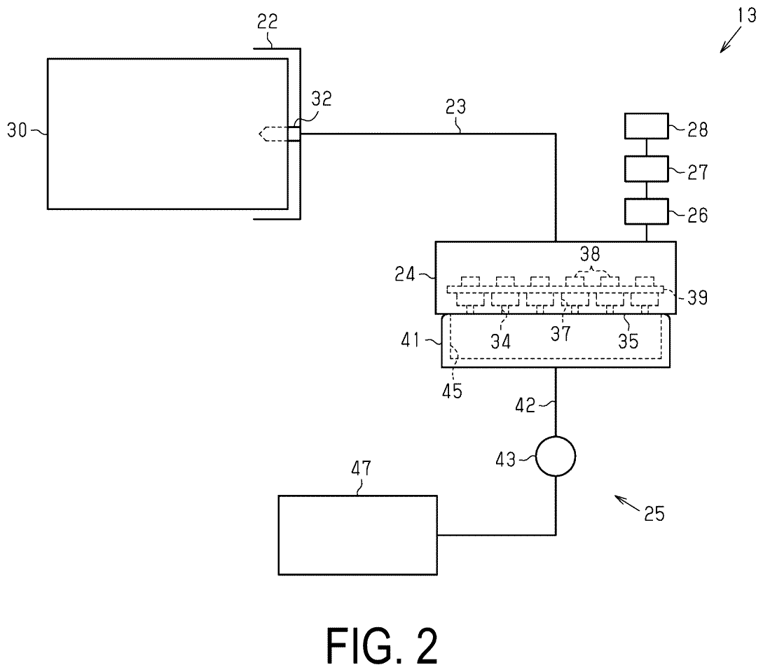

As illustrated in FIG. 2, the printing apparatus 13 may include a mounting portion 22 and a supply flow path 23. The printing apparatus 13 includes a printing head 24, a cleaning unit 25, a detector 26, a control unit 27, and a database 28.

A liquid accommodation unit 30 is attached to the mounting portion 22 in a detachable manner. A plurality of liquid accommodation units 30 may be able to be attached to the mounting portion 22. A plurality of supply flow paths 23 may be coupled to the mounting portion 22. The liquid accommodation unit 30 accommodates a liquid to be supplied to the printing head 24. A plurality of liquid accommodation units 30 may accommodate different types of liquids. The different types of liquids are, for example, different colors of ink.

An upstream end of the supply flow path 23 may be configured to include a supply needle 32. The supply needle 32 is provided at the mounting portion 22. The supply needle 32 is inserted into the liquid accommodation unit 30 mounted at the mounting portion 22, thereby being able to put out a liquid accommodated in the liquid accommodation unit 30. A downstream end of the supply flow path 23 is coupled to the printing head 24. The supply flow path 23 is configured to supply a liquid to the printing head 24 from the liquid accommodation unit 30 mounted at the mounting portion 22. The supply flow path 23 may supply the liquid through water head. The printing apparatus 13 may include a pump (not illustrated) configured to supply a liquid from the liquid accommodation unit 30 to the printing head 24.

The printing head 24 includes a nozzle surface 35 in which a plurality of nozzles 34 are opened. That is, the printing head 24 includes the plurality of nozzles 34. The printing head 24 is configured to discharge a liquid from the plurality of nozzles 34 to a medium 20 to perform printing. The printing head 24 may be configured as a serial type that discharges a liquid while moving to perform printing.

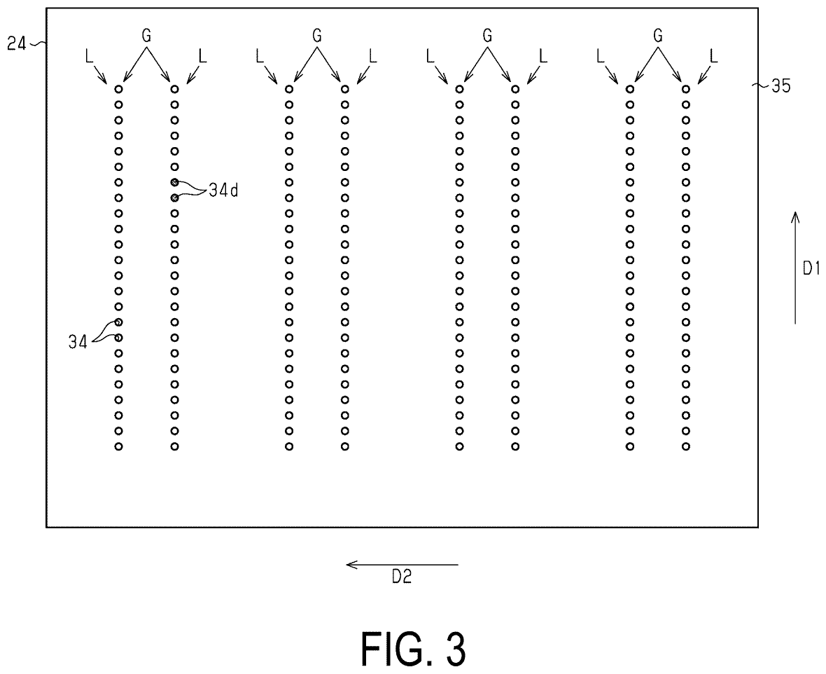

As illustrated in FIG. 3, the printing head 24 may include one or more nozzle rows L. The nozzle row L includes the plurality of nozzles 34 arrayed in a first direction D1. One nozzle row L may include several hundreds of nozzles 34, or may include 1000 or more nozzles 34. The nozzle row L includes a plurality of nozzles 34 that discharge the same type of liquid. When the printing head 24 includes a plurality of nozzle rows L, the plurality of nozzle rows L may each discharge different types of liquids. The printing head 24 may be able to discharge a plurality of types of liquids.

The printing head 24 may include a plurality of nozzle rows L configured to discharge the same type of liquid. In the present embodiment, the plurality of nozzles 34 configured to discharge the same type of liquid are also referred to as a nozzle group G. The present embodiment includes four nozzle groups G each including two nozzle rows L.

The plurality of nozzle rows L may be provided so as to be arrayed in a second direction D2. The first direction D1 and the second direction D2 may be directions extending parallel to the nozzle surface 35 and perpendicular to each other or may be directions diagonally intersecting each other.

As illustrated in FIG. 2, the printing head 24 may include a plurality of pressure chambers 37, a plurality of actuators 38, and a vibrating plate 39.

Each of the pressure chambers 37 communicates with a corresponding nozzle 34. The liquid supplied through the supply flow path 23 passes through the pressure chamber 37, and is delivered to the nozzle 34. A portion of the wall surface of the pressure chamber 37 is formed of the vibrating plate 39.

The actuator 38 is provided at a surface of the vibrating plate 39 that is opposed from a portion that faces the pressure chamber 37. In the present embodiment, the actuator 38 is configured as a piezoelectric element that contracts when a drive voltage is applied. The contracting actuator 38 deforms the vibrating plate 39. When application of a drive voltage is stopped, the actuator 38 changes a volume of the pressure chamber 37 to discharge a liquid within the pressure chamber 37 from the nozzle 34 in a form of droplet. That is, the nozzle 34 discharges a liquid pushed out from the pressure chamber 37 through drive of the actuator 38.

The actuator 38 causes the vibrating plate 39 to deform in a bending manner. Deformation of the vibrating plate 39 causes a change in pressure within the pressure chamber 37. Due to this change, the vibrating plate 39 vibrates for a while. In the present embodiment, vibration of the pressure chamber 37 occurring due to supplying a predetermined drive signal to the actuator 38 is also referred to as residual vibration. The predetermined drive signal may be a signal that enables a liquid to be discharged from the nozzle 34 or may be a signal that does not cause the liquid to be discharged.

The cleaning unit 25 includes a cap 41, a waste liquid flow path 42, and a suction pump 43. The cleaning unit 25 performs cleaning of the printing head 24.

The cap 41 is able to accommodate a liquid ejected from the nozzle 34. The cap 41 may be provided so as to be able to move to a contact position illustrated in FIG. 2 and a departing position that is not illustrated in the drawing.

The contact position is a position at which the cap 41 comes into contact with the printing head 24. The cap 41 disposed at the contact position forms a closed space 45 where the plurality of nozzles 34 open. Formation of the closed space 45 such that the cap 41 surrounds the nozzle 34 is also referred to as capping.

The departing position is a position at which the cap 41 departs from the printing head 24. The cap 41 moves from the contact position to the departing position to release the closed space 45. That is, the cap 41 disposed at the departing position does not form the closed space 45. The cap 41 disposed at the departing position may accommodate a liquid discharged from the printing head 24. Maintenance in which a liquid is discharged from the printing head 24 is also referred to as flushing.

It may be possible to employ a configuration in which an upstream end of the waste liquid flow path 42 may be coupled to the cap 41 and a downstream end thereof is coupled of the waste-liquid accommodation unit 47. The suction pump 43 is able to reduce, through the waste liquid flow path 42, the pressure in a space within the cap 41.

The cleaning unit 25 forcibly ejects a liquid from the plurality of nozzles 34 through the closed space 45, thereby being able to perform cleaning. In the present embodiment, the cleaning unit 25 drives the suction pump 43 in a state in which the cap 41 is disposed at the contact position, to perform cleaning. That is, the cleaning unit 25 reduces the pressure in the closed space 45. With this configuration, a liquid is ejected from the nozzle 34, and the liquid is supplied from the supply flow path 23 to the printing head 24.

The cleaning unit 25 is able to perform a plurality of types of cleaning. The “different types of cleaning” may means being different from each other in at least one of the amount of ejected liquid, the velocity at which the liquid flows, ejection duration in which the liquid is ejected, and the like.

For example, the cleaning unit 25 may be able to perform weak cleaning, middle cleaning, and strong cleaning, which differ from each other in the amount of ejection. Specifically, the weak cleaning may be cleaning in which a first amount of liquid is ejected. The middle cleaning may be cleaning in which a second amount of liquid is ejected, the second amount being more than the first amount. The strong cleaning may be cleaning in which a third amount of liquid is ejected, the third amount being more than the second amount.

The detector 26 may detect the state of the pressure chamber 37 and the state of the nozzle 34 communicating with the pressure chamber 37, on the basis of the state of residual vibration. In the present embodiment, the detector 26 is a circuit configured to detect the waveform of vibration of the pressure chamber 37 to detect the state of the inside of the pressure chamber 37.

In FIG. 3, a faulty nozzle 34d that does not perform discharging properly is indicated with shading. In the present embodiment, a process of detecting the faulty nozzle 34d on the basis of residual vibration is also referred to as a faulty-nozzle detecting process. The detector 26 performs the faulty-nozzle detecting process for each of the plurality of nozzles 34. The detector 26 is able to detect a discharging fault for the plurality of nozzles 34.

The discharging fault represents a state in which a liquid is not discharged from a nozzle 34, a state in which a liquid is discharged but the amount of droplet is small, or a state in which a direction of flying of the droplet deviates and the droplet does not land at a target position. The discharging fault occurs due to an increase in the viscosity of a liquid, or mixture of an air bubble, or contact of a foreign material such as a medium 20, or the like. In the present embodiment, a nozzle 34 in which a discharging fault is detected is also referred to as the faulty nozzle 34d, and a nozzle 34 in which a discharging fault is not detected is also referred to as a normal nozzle.

As illustrated in FIG. 2, the control unit 27 controls various types of operations performed in the printing apparatus 13. It may be possible to configure the control unit 27 as a circuit including α: one or more processors that perform various processing in accordance with a computer program, β: one or more dedicated hardware circuits that perform at least a portion of the various processing, or γ: a combination thereof. The hardware circuit is an application-specific integrated circuit, for example. The processor includes a CPU and a memory such as a RAM and a ROM, and the memory stores program codes or commands configured to cause the CPU to execute processing. The memory, that is, a computer readable medium includes any readable media that can be accessed by general-purpose or dedicated computers.

### Database

As illustrated in FIG. 2, the database 28 stores cause data. The cause data are data used to determine a cause of the discharging fault of a nozzle 34. The cause data are data in which a tendency of the position of the faulty nozzle 34d and the cause of the discharging fault are associated with each other. The database 28 may store recommendation cleaning data so as to be associated with the cause data. The database 28 may store past faulty nozzle information and recovery information. The recovery information is information based on the position of the faulty nozzle 34d before cleaning is performed and the position of the faulty nozzle 34d after cleaning is performed. The recovery information may be associated with information regarding cleaning that has been performed.

Specific cause data and an example of recommendation cleaning data are described below.

FIG. 3 illustrates one example of a first pattern. In the first pattern, the faulty nozzle 34d occurs in one nozzle row L, and the number of faulty nozzles 34d is less than a first threshold value. The cause of the first pattern includes a foreign material such as paper dust being attached to the nozzle 34, a foreign material entering the nozzle 34, a liquid being cured in the nozzle 34, and an increase in the viscosity of a liquid within the nozzle 34. The first threshold value may be several tens of pieces. The recommended cleaning for the first pattern is the weak cleaning.

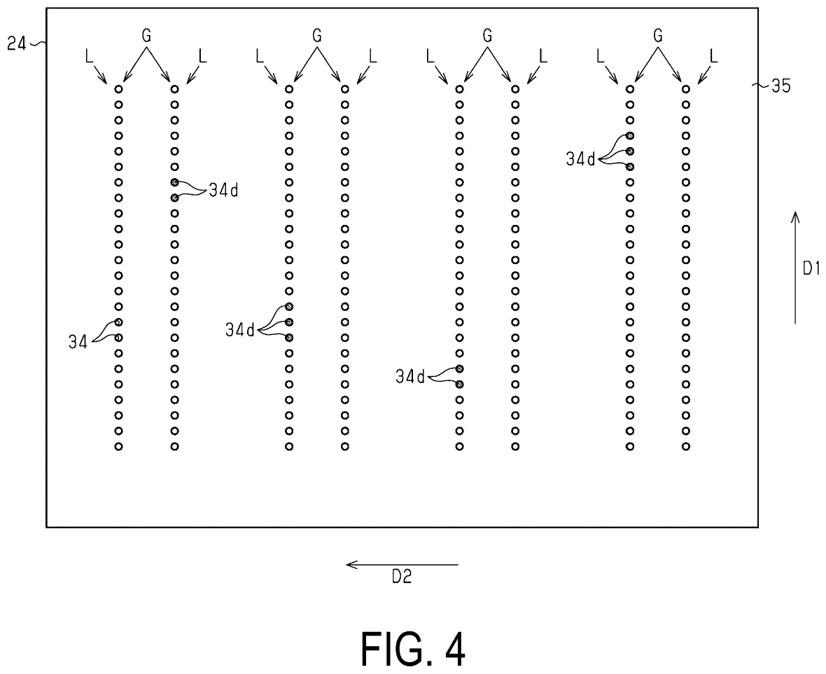

FIG. 4 illustrates one example of a second pattern. In the second pattern, the faulty nozzle 34d occurs in a plurality of nozzle rows L, and the number of faulty nozzles 34d is less than the first threshold value in each of the nozzle rows L. The cause of the second pattern includes the nozzle being continuously used in a state of a discharging fault, a fault induced by cleaning, and moisture going away from a liquid within the nozzle 34 due to moisturizer remaining in the cap 41. The recommended cleaning for the second pattern is the middle cleaning.

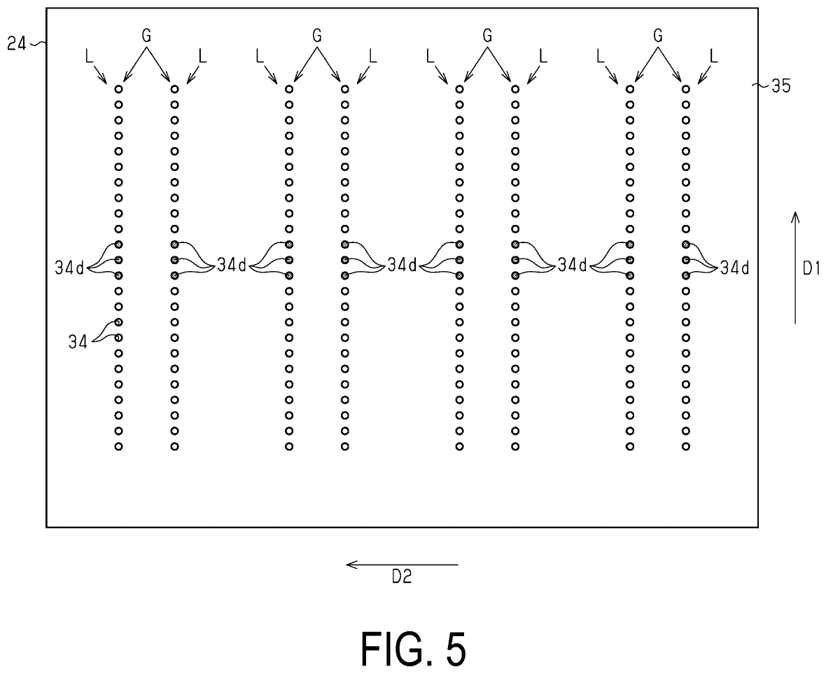

FIG. 5 illustrates one example of a third pattern. In the third pattern, faulty nozzles 34d in a plurality of nozzle rows L are arranged in a second direction D2. The cause of the third pattern includes a foreign material such as a medium 20 being brought into contact with the nozzle surface 35. The recommended cleaning for the third pattern is the middle cleaning.

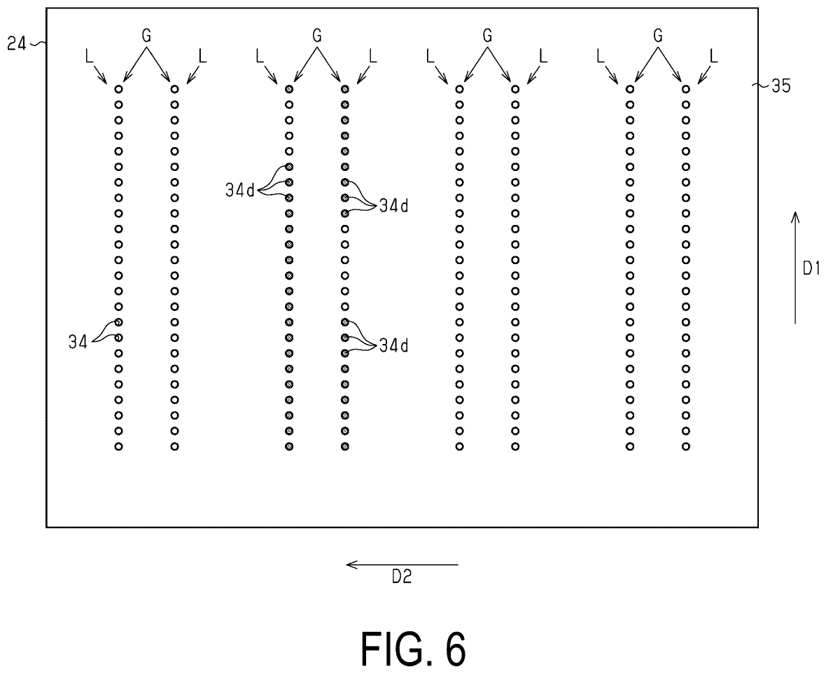

FIG. 6 illustrates one example of a fourth pattern. In the fourth pattern, faulty nozzles 34d occur in a plurality of nozzle rows L of the same nozzle group G. In one nozzle group G of the fourth pattern, the number of faulty nozzles 34d in each of the nozzle rows L is equal to or more than the first threshold value, and in other nozzle groups G, the number of faulty nozzles 34d in each of the nozzle rows L is less than the first threshold value. In a case of the fourth pattern, the cause is an air bubble within the printing head 24. The recommended cleaning for the fourth pattern is the strong cleaning.

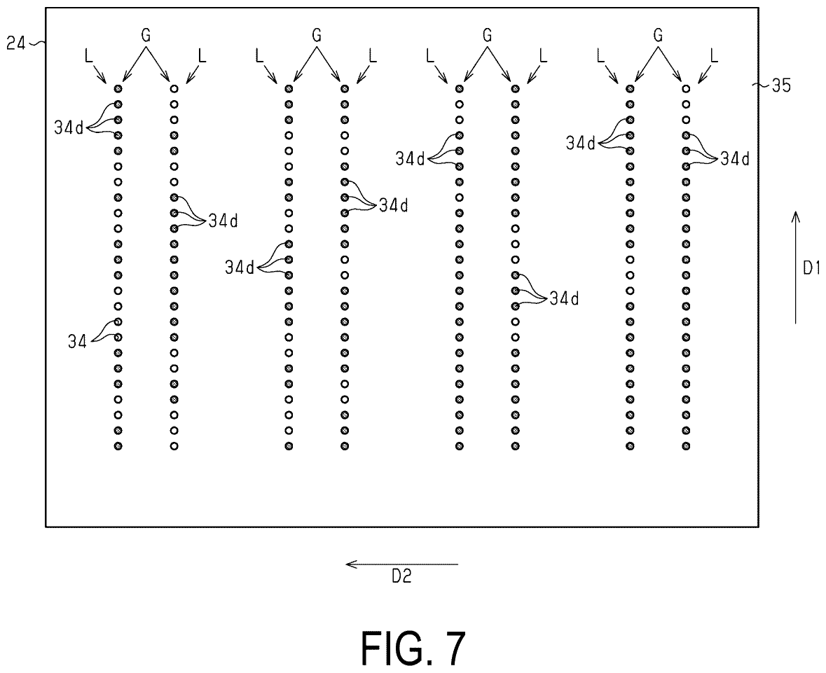

FIG. 7 illustrates one example of a fifth pattern. In the fifth pattern, faulty nozzles 34d occur in a plurality of nozzle rows L, and the number of faulty nozzles 34d in each of the nozzle rows L is equal to or more than the first threshold value. The cause of the fifth pattern includes: receiving an impact due to the printing apparatus 13 being dropped: losing moisture from a liquid within the nozzle 34 due to moisturizer left in the cap 41; an increase in the viscosity of a liquid within the printing head 24; and an air bubble within the printing head 24. Although moisturizer left in the cap 41 is given as the cause in the second pattern, the second pattern is more likely to occur at the beginning of occurrence of a discharging fault, and the fifth pattern is more likely to occur at the advanced stage of a discharging fault. The increase in the viscosity of a liquid within the printing head 24 or air bubble in the fifth pattern occurs due to the printing apparatus 13 being not used for a long period of time. An air bubble within the printing head 24 also occurs due to movement of an air bubble within the supply flow path 23 into the printing head 24 through cleaning. The recommended cleaning for the fifth pattern is the strong cleaning.

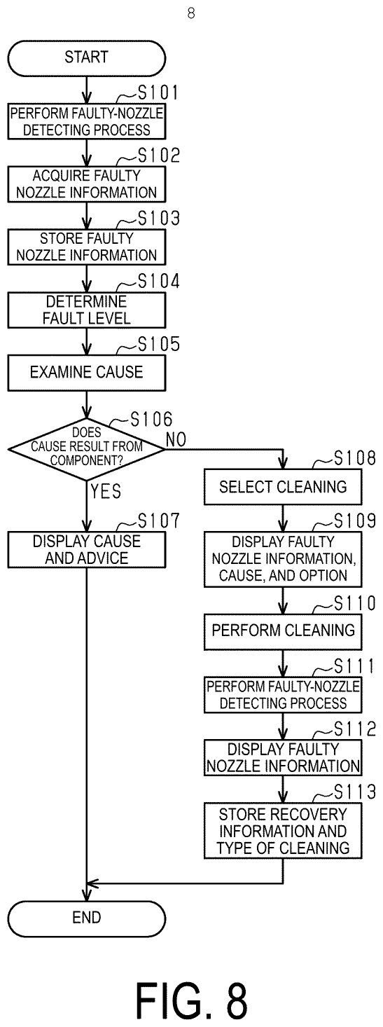

Next, a display method used to cause the display unit 16 to display information outputted by the printing apparatus 13 will be described with reference to the flowchart shown in FIG. 8. This display routine is performed at the time of turning on the power supply to the printing apparatus 13, at the time of printing, at the timing when a user gives an instruction, or the like.

In step S101, the control unit 27 may cause the detector 26 to perform the faulty-nozzle detecting process, as illustrated in FIG. 8. That is, the control unit 27 provides a predetermined drive signal to each of the actuators 38, and causes the detector 26 to detect each residual vibration.

In step S102, the control unit 27 may acquire faulty nozzle information. The faulty nozzle information includes a position, in the printing head 24, the faulty nozzle 34d detected by the detector 26.

In step S103, the control unit 27 stores the faulty nozzle information in the database 28. That is, the database 28 may include history of the faulty nozzle information.

In step S104, the control unit 27 determines a fault level. Specifically, the control unit 27 determines the fault level of the faulty nozzle 34d on the basis of the faulty nozzle information stored in the database 28. The control unit 27 may determine the fault level for each of the nozzles 34. For example, when a nozzle 34 determined to be normal in the previous faulty-nozzle detecting process is determined as a faulty nozzle 34d in the current faulty-nozzle detecting process, the control unit 27 determines this faulty nozzle 34d to have a minor fault level. For example, when a faulty nozzle 34d consecutively determined to have a discharging fault is determined as a faulty nozzle 34d in the current faulty-nozzle detecting process again, the control unit 27 determines this faulty nozzle 34d to have a serious fault level.

In step S105, the control unit 27 may examine a cause of the discharging fault. The control unit 27 may examine whether a cause of the discharging fault results from a trouble of a component that constitutes the printing apparatus 13 or from a trouble with supply of a liquid. By checking the faulty nozzle information against the cause data, the control unit 27 determines the cause. The control unit 27 may use the fault level to determine the cause.

For example, when a faulty nozzle 34d having a serious fault level occurs in one nozzle row L, the control unit 27 may determine that the printing head 24 has a fault. That is, the control unit 27 may determine that the printing head 24 that is a constituent component of the printing apparatus 13 has a problem.

For example, when a faulty nozzle 34d having a serious fault level occurs in a plurality of nozzle rows L, the control unit 27 may determine that the cap 41 has a fault. That is, the control unit 27 may determine that the cap 41 that is a constituent component of the printing apparatus 13 has a problem.

For example, when the number of faulty nozzles 34d in one nozzle row L is equal to or more than the first threshold value and the number of faulty nozzles 34d in other nozzle rows L is less than the first threshold value, the control unit 27 determines that the cause of the discharging fault as an air bubble within the printing head 24. Specifically, the control unit 27 determines that the positions of the faulty nozzles 34d fall in the fourth pattern illustrated in FIG. 6, and acquires the cause associated with the fourth pattern.

For example, when faulty nozzles 34d in a plurality of nozzle rows L are aligned in one line, the control unit 27 determines that the cause of the discharging fault is that a foreign material comes into contact with the printing head 24. Specifically, the control unit 27 determines that the positions of the faulty nozzles 34d fall in the third pattern illustrated in FIG. 5, and acquires the cause associated with the third pattern.

In step S106, the control unit 27 determines whether or not the cause of the current discharging fault results from a fault of a component.

When the cause results from a component, step S106 results in YES, and the control unit 27 moves the process to step S107. In step S107, the control unit 27 causes the display unit 16 to display guidance as to the cause of the discharging fault and replacement of the component that causes the fault. That is, when a component is the cause of the discharging fault of the nozzle 34, the control unit 27 gives advice to replace the component. The control unit 27 ends the display routine without performing cleaning.

When a component is not the cause, step S106 results in NO, and the control unit 27 moves the process to step S108. In step S108, the control unit 27 selects cleaning to be performed by the cleaning unit 25. By checking the faulty nozzle information against the cause data, the control unit 27 may select cleaning. The control unit 27 may select cleaning associated with the cause of the current discharging fault. For example, when a tendency of the position of the faulty nozzle 34d this time falls in the first pattern, the control unit 27 may select the weak cleaning that is the recommended cleaning for the first pattern.

The control unit 27 may select cleaning to be performed by the cleaning unit 25, on the basis of the tendency of the discharging fault. For example, the control unit 27 may select cleaning to be performed by the cleaning unit 25, on the basis of the previous faulty nozzle information and the current faulty nozzle information.

For example, when the tendency of the position of the faulty nozzle 34d this time falls in the first pattern and the tendency of the faulty nozzle 34d in the previous time falls in the third pattern, the control unit 27 may select the middle cleaning. For example, when the tendency of the position of the faulty nozzle 34d falls in the first pattern for both the previous time and this time, and the same nozzle 34 has the discharging fault, the control unit 27 may select the middle cleaning.

The control unit 27 may select cleaning on the basis of the recovery information. For example, when the discharging fault is not corrected through cleaning performed in the past, the control unit 27 may select cleaning with the amount of ejection greater than the cleaning that is performed in the past. Specifically, when the same nozzle 34 results in a discharging fault even after the weak cleaning is performed in the past, the control unit 27 may select the middle cleaning.

For example, when a discharging fault is sufficiently corrected through cleaning performed in the past, the control unit 27 may select cleaning with the amount of ejection less than the cleaning performed in the past. Specifically, when a discharging fault is recovered with a high probability as a result of the middle cleaning being performed to the discharge fault having the second pattern, the control unit 27 may select the weak cleaning to the discharge fault having the second pattern. The control unit 27 may re-write the recommended cleaning.

In step S109, the control unit 27 may cause the display unit 16 to display information regarding cleaning to be performed by the cleaning unit 25. In the present embodiment, the control unit 27 causes the display unit 16 to display the faulty nozzle information, the cause of the discharging fault of the nozzle 34, and an option of cleaning to be performed by the cleaning unit 25. The control unit 27 may cause the display unit to display the selected cleaning as an option. That is, a user may enter an instruction to perform the displayed cleaning, or may give an instruction to perform cleaning differing from the displayed cleaning. The control unit 27 may cause the display unit to display, as an option, a plurality of pieces of cleaning including the selected cleaning.

In step S110, the control unit 27 causes the cleaning unit 25 to perform the selected cleaning or cleaning that the user gives an instruction to perform.

In step S111, the control unit 27 may cause the detector 26 to perform the faulty-nozzle detecting process. The detector 26 may perform the faulty-nozzle detecting process before and after the cleaning unit 25 performs cleaning.

In step S112, the control unit 27 may cause the display unit 16 to display the faulty nozzle information after cleaning is performed.

In step S113, the control unit 27 may store the recovery information in the database 28. The control unit 27 may store, in the database 28, the recovery information, and the type of cleaning that the cleaning unit 25 is caused to perform. The recovery information is information based on the position of the faulty nozzle 34d before the cleaning is performed and the position of the faulty nozzle 34d after cleaning is performed.

### Effects of Embodiment

### Operations of the Present Embodiment Will be Described.

The control unit 27 checks the faulty nozzle information against the cause data to select cleaning to be performed by the cleaning unit 25. The control unit 27 causes the display unit 16 to display the faulty nozzle information together with the cause of the discharging fault of the nozzle 34 and an option of cleaning.

### Effects of Embodiment

### Effects of the Present Embodiment Will be Described.

(1-1) The control unit 27 checks the faulty nozzle information against the cause data to select cleaning to be performed by the cleaning unit 25. The cause data are data used to determine a cause of the discharging fault of a nozzle 34. Thus, it is possible to select cleaning while considering the cause of the discharging fault of the nozzle 34, thereby being able to reduce the amount of consumption of the liquid.

(1-2) The control unit 27 selects cleaning using the current faulty nozzle information as well as the previous faulty nozzle information. This makes it possible to select more appropriate cleaning.

(1-3) The control unit 27 determines the fault level of the faulty nozzle 34d on the basis of the faulty nozzle information stored in the database 28. This allows the control unit 27 to select cleaning that matches the fault level.

(1-4) The database 28 stores the past faulty nozzle information. This makes it possible to select more appropriate cleaning by considering the tendency of the discharging fault.

(1-5) The control unit 27 determines the cause of the discharging fault on the basis of the type of a liquid that a nozzle 34 having the discharging fault discharges, the number of faulty nozzles 34d, and the position of the faulty nozzle 34d. This makes it possible to easily determine the cause of the discharging fault.

(1-6) When faulty nozzles 34d in a plurality of nozzle rows L are aligned in one line, the control unit 27 determines that the cause of the discharging fault is that a foreign material comes into contact with the printing head 24. That is, the control unit 27 determines the cause of the discharging fault on the basis of the positions of the faulty nozzles 34d. This makes it possible to easily determine the cause of the discharging fault.

(1-7) When the cause of a discharging fault results from a component, the discharging fault is less likely to be corrected even if cleaning is performed. In this regard, when the cause of the discharging fault of a nozzle 34 results from a component, the control unit 27 gives advice to replace the component. This makes it possible to reduce the amount of consumption of the liquid by the amount in which cleaning is not performed.

(1-8) The control unit 27 causes the database 28 to store the recovery information based on the positions of a faulty nozzle 34d before and after cleaning is performed. This makes it possible to examine the effect of cleaning.

(1-9) The control unit 27 selects cleaning on the basis of the recovery information. This makes it possible to select more appropriate cleaning.

(1-10) The control unit 27 causes the display unit 16 to display information that causes the cleaning unit 25 to perform. This makes it possible to let a user know what kind of cleaning is performed by the cleaning unit 25.

(1-11) The detector 26 performs the faulty-nozzle detecting process in which a faulty nozzle 34d is detected on the basis of residual vibration of the pressure chamber 37. This makes it possible to detect the faulty nozzle 34d by using the configuration in which a liquid is discharged from a nozzle 34.

(1-12) The display unit 16 displays the faulty nozzle information, the cause of a discharging fault, and an option of cleaning. This enables a user to select cleaning while considering the cause of the discharging fault. Thus, it is possible for the user to select appropriate cleaning.

(1-13) The control unit 27 causes cleaning to be displayed as an option, the cleaning being selected by considering the cause of the discharging fault of a nozzle 34. This makes it possible for a user to easily select appropriate cleaning.

(1-14) The control unit 27 causes a plurality of pieces of cleaning to be displayed as options, the cleanings including cleaning selected by considering the cause of the discharging fault of a nozzle 34. This makes it possible for a user to easily select appropriate cleaning.

(1-15) The detector 26 also detects a faulty nozzle 34d after cleaning is performed. The control unit 27 causes the position of a fault nozzle 34d before cleaning is performed and the position of a faulty nozzle 34d after cleaning is performed, to be displayed. This makes it possible to indicate the effect of cleaning.

(1-16) The control unit 27 causes the database 28 to store recovery information based on the positions of the faulty nozzle 34d before and after cleaning is performed and the type of cleaning performed. This makes it possible to examine the effect of cleaning.

### Modification Examples

It may be possible to modify the present embodiment in the following manner, and implement it. It may be possible to combine the present embodiment and the following modification examples as long as the combination does not contract technically, and implement it.
The control unit 27 may select cleaning without considering the recovery information. The control unit 27 may not store the recovery information in the database 28.
The control unit 27 may not perform the faulty-nozzle detecting process after cleaning is performed. The control unit 27 may not cause the display unit 16 to display the faulty nozzle information after cleaning.
The control unit 27 may perform the faulty-nozzle detecting process after cleaning is performed, to a nozzle 34 determined to have a discharging fault before cleaning is performed. That is, the control unit 27 may not perform the faulty-nozzle detecting process after cleaning, to a nozzle 34 determined to be normal before cleaning. By limiting the number of nozzles 34 to perform the faulty-nozzle detecting process, it is possible to reduce the period of time required for the faulty-nozzle detecting process.
The control unit 27 may update the recommendation cleaning data stored in the database 28, on the basis of the recovery information.
The control unit 27 may not examine whether or not the cause of the discharging fault of the nozzle 34 results from a component that constitutes the printing apparatus 13. When a discharging fault occurs, the control unit 27 may select cleaning on the assumption that there is a trouble in supplying a liquid.
The control unit 27 may not store the faulty nozzle information in the database 28. The database 28 may not have the history of the faulty nozzle information. The control unit 27 may select cleaning without considering the tendency of a discharging fault. The control unit 27 may select cleaning without considering the fault level. The control unit 27 may select cleaning on the basis of the faulty nozzle information acquired by performing the faulty-nozzle detecting process.
The printing system 11 may include the server device 12 including the database 28. That is, the server device 12, rather than the printing apparatus 13, may include the database 28.
The control unit 27 may cause the cleaning unit 25 to perform cleaning without causing the display unit 16 to display information regarding cleaning.
The cleaning unit 25 may include a pressure pump (not illustrated) configured to pressurize a liquid within the printing head 24. The cleaning unit 25 may perform pressurized cleaning.
The detector 26 may include a sensor configured to detect a discharged liquid. The sensor may detect that a liquid is attached, or may detect light blocked by a discharged liquid. The detector 26 may cause a liquid to be discharged from a nozzle 34 and detect the discharged liquid. The detector 26 may determine, as a faulty nozzle 34d, a nozzle 34 for which the discharged liquid cannot be detected.
The printing apparatus 13 is an apparatus that prints an image such as a character, a picture, and a photograph by attaching a liquid such as ink or fluid such as toner on the medium, and may be a serial printer, a lateral printer, a line printer, a page printer, or the like. In addition, the printing apparatus may be an offset printing apparatus, a textile printing apparatus, or the like.

### Definition

An expression “at least one” as used herein means “one or more” of desired options. As an example, an expression “at least one” as used herein means “only one option” or “both of two options” when the number of options is two. As another example, the expression “at least one” as used herein means “only one option” or “any combination of two or more options” or “any combination of three or more options” when the number of options is three or more.

### Appendix

The technical ideas and their operation and effects that can be obtained from the embodiment and modification examples described above will be described below.

(A) A printing apparatus includes: a printing head including a plurality of nozzles configured to discharge a liquid; a cleaning unit configured to perform cleaning of the printing head; a detector configured to perform a faulty-nozzle detecting process to each of the plurality of nozzles, the faulty-nozzle detecting process being a process of detecting a faulty nozzle that does not perform discharging properly; a database configured to store cause data used to determine a cause of a discharging fault of the nozzle; and a control unit, in which the control unit checks faulty nozzle information against the cause data to select cleaning to be performed by the cleaning unit, the faulty nozzle information including a position, in the printing head, of the faulty nozzle detected by the detector.

With this configuration, the control unit checks the faulty nozzle information against the cause data, thereby selecting cleaning to be performed by the cleaning unit. The cause data are data used to determine the cause of the discharging fault of a nozzle. Thus, it is possible to select cleaning while taking the cause of the discharging fault of a nozzle into consideration, which makes it possible to reduce the amount of consumption of the liquid.

(B) The printing apparatus according to (A) may be configured such that the control unit stores the faulty nozzle information in the database, and selects cleaning to be performed by the cleaning unit on the basis of the faulty nozzle information at previous time and the faulty nozzle information at this time.

With this configuration, the control unit selects cleaning using the faulty nozzle information at the previous time, in addition to the faulty nozzle information at this time. This makes it possible to select more appropriate cleaning.

(C) The printing apparatus according to (B) may be configured such that the control unit determines a fault level of the faulty nozzle on the basis of the faulty nozzle information stored in the database.

With this configuration, the control unit determines the fault level of the faulty nozzle on the basis of the faulty nozzle information stored in the database. This makes it possible to select cleaning that matches the fault level.

(D) The printing apparatus according to (B) or (C) may be configured such that the control unit selects cleaning to be performed by the cleaning unit on the basis of a tendency of the discharging fault.

With this configuration, the past faulty nozzle information is stored in the database. Thus, by considering the tendency of the discharging fault, it is possible to select more appropriate cleaning.

(E) The printing apparatus according to (A) to (D) may be configured such that the printing head is configured to discharge a plurality of types of liquid, and includes a plurality of nozzle rows including a plurality of the nozzles configured to discharge an identical type of liquid, and when the number of the faulty nozzles in one or more of the nozzle rows configured to discharge an identical type of liquid is equal to or more than a first threshold value, and the number of faulty nozzles in one or more of the nozzle rows configured to discharge another type of liquid is less than the first threshold value, the control unit determines that a cause of the discharging fault is an air bubble in the printing head.

With this configuration, the control unit determines the cause of the discharging fault, on the basis of the type of a liquid discharged from a nozzle having a discharging fault, the number of faulty nozzles, and the position of the faulty nozzle. This makes it possible to easily determine the cause of the discharging fault.

(F) The printing apparatus according to (A) to (E) may be configured such that the printing head is configured to discharge a plurality of types of liquid, and includes a plurality of nozzle rows including a plurality of the nozzles configured to discharge an identical type of liquid, and when the faulty nozzle in a plurality of the nozzle rows is aligned in one line, determination is made such that a cause of a discharging fault is that a foreign material comes into contact with the printing head.

With this configuration, when faulty nozzles in a plurality of the nozzle rows are aligned in one line, the control unit determines that the cause of a discharging fault is that a foreign material comes into contact with the printing head. That is, the control unit determines the cause of the discharging fault on the basis of the position of the faulty nozzle. This makes it possible to easily determine the cause of the discharging fault.

(G) The printing apparatus according to (A) to (F) is configured such that, when a cause of a discharging fault of the nozzle results from a component, the control unit gives advice to replace the component.

When a cause of a discharging fault results from a component, the discharging fault is less likely to be corrected even if cleaning is performed. In this regard, with this configuration, when the cause of the discharging fault of the nozzle results from a component, the control unit gives advice to replace the component. This makes it possible to reduce the amount of consumption of the liquid by the amount in which cleaning is not performed.

(H) The printing apparatus according to (A) to (G) may be configured such that the control unit causes the database to store recovery information based on a position of the faulty nozzle before cleaning is performed and a position of the faulty nozzle after cleaning is performed.

With this configuration, the control unit causes the database to store the recovery information based on positions of faulty nozzles before and after cleaning is performed. This makes it possible to examine the effect of cleaning.

(I) The printing apparatus according to (H) may be configured such that the control unit selects cleaning to be performed by the cleaning unit, on the basis of the recovery information.

With this configuration, the control unit selects cleaning on the basis of recovery information. This makes it possible to select more appropriate cleaning.

(J) The printing apparatus according to (A) to (I) may be configured such that the control unit causes a display unit to display information regarding cleaning to be performed by the cleaning unit.

With this configuration, the control unit causes the display unit to display information to be performed by the cleaning unit. This makes it possible to let a user know what kind of cleaning is performed by the cleaning unit.

(K) The printing apparatus according to (A) to (J) may be configured such that the printing head pushes out a liquid within a pressure chamber with drive of an actuator to cause the liquid to be discharged from a plurality of the nozzles, and the faulty-nozzle detecting process is a process of detecting the faulty nozzle on the basis of residual vibration of the pressure chamber that occurs due to a predetermined drive signal being supplied to the actuator.

With this configuration, the detector performs the faulty-nozzle detecting process to detect the faulty nozzle on the basis of the residual vibration of the pressure chamber. This makes it possible to detect the faulty nozzle using the configuration in which a liquid is discharged from the nozzle.

(L) A printing system includes: a printing head including a plurality of nozzles configured to discharge a liquid; a cleaning unit configured to perform cleaning of the printing head; a detector configured to perform a faulty-nozzle detecting process to each of the plurality of nozzles, the faulty-nozzle detecting process being a process of detecting a faulty nozzle that does not perform discharging properly; a database configured to store cause data used to determine a cause of a discharging fault of the nozzle; and a control unit, in which the control unit checks faulty nozzle information against the cause data to select cleaning to be performed by the cleaning unit, the faulty nozzle information including a position, in the printing head, of the faulty nozzle detected by the detector. This configuration also makes it possible to achieve the effect similar to that of the printing apparatus described above.

(M) A database that a printing apparatus checks faulty nozzle information against, the printing apparatus including: a printing head including a plurality of nozzles configured to discharge a liquid; a cleaning unit configured to perform cleaning of the printing head; a detector configured to perform a faulty-nozzle detecting process to each of the plurality of nozzles, the faulty-nozzle detecting process being a process of detecting a faulty nozzle that does not perform discharging properly; and a control unit, in which the printing apparatus checks faulty nozzle information against the database to select cleaning to be performed by the cleaning unit, the faulty nozzle information including a position, in the printing head, of the faulty nozzle detected by the detector, and the database is configured to store cause data used to determine a cause of a discharging fault of the nozzle. This configuration also makes it possible to achieve the effect similar to that of the printing apparatus described above.

(N) A printing apparatus including: a printing head including a plurality of nozzles configured to discharge a liquid; a cleaning unit configured to perform cleaning of the printing head; a display unit configured to display information; a detector configured to perform a faulty-nozzle detecting process to each of the plurality of nozzles, the faulty-nozzle detecting process being a process of detecting a faulty nozzle that does not perform discharging properly; a database configured to store cause data used to determine a cause of a discharging fault of the nozzle; and a control unit, in which the control unit causes the display unit to display: faulty nozzle information including a position, in the printing head, of the faulty nozzle detected by the detector; a cause of a discharging fault of the nozzle; and an option of cleaning performed by the cleaning unit.

With this configuration, the display unit displays the faulty nozzle information, the cause of a discharging fault, and the option of cleaning. This enables a user to select cleaning while considering the cause of the discharging fault. This makes it possible to cause appropriate cleaning to be selected.

(O) The printing apparatus according to (N) may be configured such that the control unit checks the faulty nozzle information against the cause data to select cleaning, and causes the selected cleaning to be displayed as the option.

With this configuration, the control unit causes the cleaning selected by taking the cause of the discharging fault of the nozzle into consideration, to be displayed as an option. This makes it possible for a user to easily select appropriate cleaning.

(P) The printing apparatus according to (N) may be configured such that the control unit checks the faulty nozzle information against the cause data to select cleaning, and causes a plurality of pieces of cleaning including the selected cleaning to be displayed as the option.

With this configuration, the control unit causes a plurality of pieces of cleaning including the cleaning selected by taking the cause of the discharging fault of the nozzle into consideration, to be displayed as an option. This makes it possible for a user to easily select appropriate cleaning.

(Q) The printing apparatus according to (N) to (P) may be configured such that the detector performs the faulty-nozzle detecting process before and after the cleaning unit performs cleaning, and the control unit causes the display unit to display the faulty nozzle information after cleaning is performed.

With this configuration, the detector detects a faulty nozzle even after cleaning is performed. The control unit causes display to be performed of a position of a faulty nozzle before cleaning is performed and a position of a faulty nozzle after cleaning is performed. This makes it possible to indicate the effect of cleaning.

(R) The printing apparatus according to (Q) may be configured such that the control unit causes the database to store recovery information and a type of cleaning that the cleaning unit is caused to perform, the recovery information being based on a position of the faulty nozzle before cleaning is performed and a position of the faulty nozzle after cleaning is performed.

With this configuration, the control unit causes the database to store the recovery information based on positions of faulty nozzles before and after cleaning is performed and also store the type of cleaning performed. This makes it possible to examine the effect of cleaning.

(S) The printing apparatus according to (N) to (R) may be configured such that the control unit causes the database to store the faulty nozzle information, and determines a fault level of the faulty nozzle on the basis of the faulty nozzle information stored in the database.

With this configuration, the control unit determines the fault level of the faulty nozzle on the basis of the faulty nozzle information stored in the database. This makes it possible to select cleaning that matches the fault level.

(T) The printing apparatus according to (N) to (S) may be configured such that the printing head is able to discharge a plurality of types of liquid, and includes a plurality of nozzle rows including a plurality of the nozzles configured to discharge the same type of liquid, and when the number of the faulty nozzles in one or more of the nozzle rows configured to discharge the same type of liquid is equal to or more than the first threshold value, and the number of faulty nozzles in one or more of the nozzle rows configured to discharge another type of liquid is less than the first threshold value, the control unit determines that a cause of the discharging fault is an air bubble in the printing head.

With this configuration, the control unit determines the cause of the discharging fault, on the basis of the type of a liquid discharged from a nozzle having a discharging fault, the number of faulty nozzles, and the position of the faulty nozzle. This makes it possible to easily determine the cause of the discharging fault.

(U) The printing apparatus according to (N) to (T) may be configured such that the printing head is configured to discharge a plurality of types of liquid, and includes a plurality of nozzle rows including a plurality of the nozzles configured to discharge the same type of liquid, and when the faulty nozzles in a plurality of the nozzle rows are aligned in one line, the control unit determines that a cause of a discharging fault is that a foreign material comes into contact with the printing head.

With this configuration, when faulty nozzles in a plurality of the nozzle rows are aligned in one line, the control unit determines that the cause of a discharging fault is that a foreign material comes into contact with the printing head. That is, the control unit determines the cause of the discharging fault on the basis of the position of the faulty nozzle. This makes it possible to easily determine the cause of the discharging fault.

(V) The printing apparatus according to (N) to (U) may be configured such that the control unit stores the faulty nozzle information in the database, and selects cleaning to be performed by the cleaning unit on the basis of the faulty nozzle information at previous time and the faulty nozzle information at this time.

With this configuration, the control unit selects cleaning using the faulty nozzle information at the previous time, in addition to the faulty nozzle information at this time. This makes it possible to select more appropriate cleaning.

(W) The printing apparatus according to (V) may be configured such that the control unit selects cleaning to be performed by the cleaning unit on the basis of a tendency of the discharging fault.

With this configuration, the past faulty nozzle information is stored in the database. Thus, by considering the tendency of the discharging fault, it is possible to select more appropriate cleaning.

(X) The printing apparatus according to (N) to (W) is configured such that, when a cause of a discharging fault of the nozzle results from a component, the control unit gives advice to replace the component.

When the cause of the discharging fault results from a component, the discharging fault is less likely to be corrected even if cleaning is performed. In this regard, with this configuration, when the cause of the discharging fault of the nozzle results from a component, the control unit gives advice to replace the component. This makes it possible to reduce the amount of consumption of the liquid by the amount in which cleaning is not performed.

(Y) The printing apparatus according to (N) to (X) may be configured such that the control unit causes the database to store recovery information based on a position of the faulty nozzle before cleaning is performed and a position of the faulty nozzle after cleaning is performed.

With this configuration, the control unit causes the database to store the recovery information based on positions of faulty nozzles before and after cleaning is performed. This makes it possible to examine the effect of cleaning.

(Z) The printing apparatus according to (Y) may be configured such that the control unit select cleaning on the basis of the recovery information.

With this configuration, the control unit selects cleaning on the basis of recovery information. This makes it possible to select more appropriate cleaning.

(AA) The printing apparatus according to (N) to (Z) may be configured such that the printing head pushes out a liquid within a pressure chamber with drive of an actuator to cause the liquid to be discharged from a plurality of the nozzles, and the faulty-nozzle detecting process is a process of detecting the faulty nozzle on the basis of residual vibration of the pressure chamber that occurs due to a predetermined drive signal being supplied to the actuator.

With this configuration, the detector performs the faulty-nozzle detecting process to detect the faulty nozzle on the basis of the residual vibration of the pressure chamber. This makes it possible to detect the faulty nozzle using the configuration in which a liquid is discharged from the nozzle.

(AB) A display method that causes a display unit to display information outputted by a printing apparatus, the printing apparatus including: a printing head including a plurality of nozzles configured to discharge a liquid; a cleaning unit configured to perform cleaning of the printing head; a detector configured to perform a faulty-nozzle detecting process to each of the plurality of nozzles, the faulty-nozzle detecting process being a process of detecting a faulty nozzle that does not perform discharging properly; and a database configured to store cause data used to determine a cause of a discharging fault of the nozzle, the method including: displaying faulty nozzle information including a position, in the printing head, of the faulty nozzle detected by the detector; displaying a cause of a discharging fault of the nozzle that is determined by checking the faulty nozzle information against the cause data; and displaying an option of cleaning to be performed by the cleaning unit. This method makes it possible to achieve the effect similar to the printing apparatus.

(AC) A display device that displays information outputted by a printing apparatus, the printing apparatus including: a printing head including a plurality of nozzles configured to discharge a liquid; a cleaning unit configured to perform cleaning of the printing head; a detector configured to perform a faulty-nozzle detecting process to each of the plurality of nozzles, the faulty-nozzle detecting process being a process of detecting a faulty nozzle that does not perform discharging properly; and a database configured to store cause data used to determine a cause of a discharging fault of the nozzle, the display device being configured to display: faulty nozzle information including a position, in the printing head, of the faulty nozzle detected by the detector; a cause of a discharging fault of the nozzle determined by checking the faulty nozzle information against the cause data; and an option of cleaning to be performed by the cleaning unit. This configuration also makes it possible to achieve the effect similar to that of the printing apparatus described above.

(AD) An information processing method performed in a printing apparatus, the printing apparatus including: a printing head including a plurality of nozzles configured to discharge a liquid; a cleaning unit configured to perform cleaning of the printing head; a detector configured to perform a faulty-nozzle detecting process to each of the plurality of nozzles, the faulty-nozzle detecting process being a process of detecting a faulty nozzle that does not perform discharging properly; and a database configured to store cause data used to determine a cause of a discharging fault of the nozzle, the information processing method including: acquiring faulty nozzle information including a position, in the printing head, of the faulty nozzle detected by the detector; checking the faulty nozzle information against the cause data to determine a case of a discharging fault of the nozzle; creating an option of cleaning to be performed by the cleaning unit; and outputting, to a display unit, the faulty nozzle information, the cause of the discharging fault of the nozzle, and the option. This method makes it possible to achieve the effect similar to the printing apparatus.

What is claimed is:

1. A printing apparatus comprising:
a printing head including a plurality of nozzles configured to discharge a liquid;
a cleaning unit configured to perform cleaning of the printing head;
a detector configured to perform a faulty-nozzle detecting process to each of the plurality of nozzles, the faulty-nozzle detecting process being a process of detecting a faulty nozzle that does not perform discharging properly;
a database configured to store cause data used to determine a cause of a discharging fault of the nozzle; and
a control unit, wherein
the control unit checks faulty nozzle information against the cause data to select cleaning to be performed by the cleaning unit, the faulty nozzle information including a position, in the printing head, of the faulty nozzle detected by the detector.

2. The printing apparatus according to claim 1, wherein
the control unit stores the faulty nozzle information in the database, and selects cleaning to be performed by the cleaning unit on a basis of the faulty nozzle information at previous time and the faulty nozzle information at this time.

3. The printing apparatus according to claim 2, wherein
the control unit determines a fault level of the faulty nozzle on a basis of the faulty nozzle information stored in the database.

4. The printing apparatus according to claim 2, wherein
the control unit selects cleaning to be performed by the cleaning unit on a basis of a tendency of the discharging fault.

5. The printing apparatus according to claim 1, wherein
the printing head is configured to discharge a plurality of types of liquid, and includes a plurality of nozzle rows including a plurality of the nozzles configured to discharge an identical type of liquid, and
when the number of the faulty nozzles in one or more of the nozzle rows configured to discharge an identical type of liquid is equal to or more than a first threshold value, and the number of faulty nozzles in one or more of the nozzle rows configured to discharge another type of liquid is less than the first threshold value, the control unit determines that a cause of a discharging fault is an air bubble in the printing head.

6. The printing apparatus according to claim 1, wherein
the printing head is configured to discharge a plurality of types of liquid, and includes a plurality of nozzle rows including a plurality of the nozzles configured to discharge an identical type of liquid, and
when the faulty nozzle in a plurality of the nozzle rows is aligned in one line, the control unit determines that a cause of a discharging fault is that a foreign material comes into contact with the printing head.

7. The printing apparatus according to claim 1, wherein
when a cause of a discharging fault of the nozzle results from a component, the control unit gives advice to replace the component.

8. The printing apparatus according to claim 1, wherein
the control unit causes the database to store recovery information based on a position of the faulty nozzle before cleaning is performed and a position of the faulty nozzle after cleaning is performed.

9. The printing apparatus according to claim 8, wherein
the control unit selects cleaning to be performed by the cleaning unit, on a basis of the recovery information.

10. The printing apparatus according to claim 1, wherein
the control unit causes a display unit to display information regarding cleaning to be performed by the cleaning unit.

11. The printing apparatus according to claim 1, wherein
the printing head pushes out a liquid within a pressure chamber with drive of an actuator to cause the liquid to be discharged from a plurality of the nozzles, and
the faulty-nozzle detecting process is a process of detecting the faulty nozzle on a basis of residual vibration of the pressure chamber that occurs due to a predetermined drive signal being supplied to the actuator.

12. The printing apparatus according to claim 1 further comprising:
a display unit configured to display information, wherein
the control unit causes the display unit to display:
faulty nozzle information including a position, in the printing head, of the faulty nozzle detected by the detector;
a cause of a discharging fault of the nozzle; and
an option of cleaning performed by the cleaning unit.

13. The printing apparatus according to claim 12, wherein
the control unit checks the faulty nozzle information against the cause data to select cleaning, and causes the selected cleaning to be displayed as the option.

14. The printing apparatus according to claim 12, wherein
the control unit checks the faulty nozzle information against the cause data to select cleaning, and causes a plurality of pieces of cleaning including the selected cleaning to be displayed as the option.

15. The printing apparatus according to claim 1, wherein
the detector performs the faulty-nozzle detecting process before and after the cleaning unit performs cleaning, and
the control unit causes the display unit to display the faulty nozzle information after cleaning is performed.

16. A printing system comprising:
a printing head including a plurality of nozzles configured to discharge a liquid;
a cleaning unit configured to perform cleaning of the printing head;
a detector configured to perform a faulty-nozzle detecting process to each of the plurality of nozzles, the faulty-nozzle detecting process being a process of detecting a faulty nozzle that does not perform discharging properly;
a database configured to store cause data used to determine a cause of a discharging fault of the nozzle; and
a control unit, wherein
the control unit checks faulty nozzle information against the cause data to select cleaning to be performed by the cleaning unit, the faulty nozzle information including a position, in the printing head, of the faulty nozzle detected by the detector.

17. A database that a printing apparatus checks faulty nozzle information against,
the printing apparatus comprising:
a printing head including a plurality of nozzles configured to discharge a liquid;
a cleaning unit configured to perform cleaning of the printing head;
a detector configured to perform a faulty-nozzle detecting process to each of the plurality of nozzles, the faulty-nozzle detecting process being a process of detecting a faulty nozzle that does not perform discharging properly; and
a control unit, wherein
the printing apparatus checks faulty nozzle information against the database to select cleaning to be performed by the cleaning unit, the faulty nozzle information including a position, in the printing head, of the faulty nozzle detected by the detector, and
the database is configured to store cause data used to determine a cause of a discharging fault of the nozzle.
